(19) United States
(12) Patent Application Publication
(10) Pub. No.: US 2012/0176651 A1
(43) Pub. Date: Jul. 12, 2012

(54) Secure Watermarking of Print Jobs Using a Smartcard

(75) Inventors: Steve Pham, Irvine, CA (US); Jianxin Wang, Trabuco Canyon, CA (US)

(73) Assignees: Toshiba Tec Kabushiki Kaisha, Shinagawa-ku (JP); Kabushiki Kaisha Toshiba, Minato-Ku (JP)

(21) Appl. No.: 13/286,879

(22) Filed: Nov. 1, 2011

Related U.S. Application Data
(60) Provisional application No. 61/431,794, filed on Jan. 11, 2011.

(51) Int. Cl. G06K 15/00

(52) U.S. Cl. 358/3.28; 358/1.14

(57) ABSTRACT

There is disclosed a method and apparatus for secure watermarking of print jobs using a smartcard. The method includes receiving, from a user, a request to print a document with a secured watermark and obtaining authorization data from a smartcard provided by the user. The method further includes receiving, from the user, a pin associated with the smartcard and obtaining authorization to print with a secured watermark from an authorization server based on the authorization data and the user pin. The method further includes obtaining a listing of secured watermarks available on a multifunction peripheral, receiving, from the user, a selection of a selected secured watermark from the listing of secured watermarks, and transmitting a print request to the multifunction peripheral, the print request including a secured watermark instruction and authorization to use the selected secured watermark.

### RELATED APPLICATION INFORMATION

This patent claims priority from U.S. Provisional Patent Application No. 61/431,794 entitled “Secure Watermarking of Print Jobs with Smartcards” filed Jan. 11, 2011.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by anyone of the patent disclosure as it appears in the Patent and Trademark Office patent files or records, but otherwise reserves all copyright and trade dress rights whatsoever.

### BACKGROUND

1. Field

This disclosure relates to secure watermarking of print jobs using a smartcard.

2. Description of the Related Art

A multifunction peripheral (MFP) is a type of document processing device which is an integrated device providing at least two document processing functions, such as print, copy, scan and fax. In a document processing function, an input document (electronic or physical) is used to automatically produce a new output document (electronic or physical).

Documents may be physically or logically divided into pages. A physical document is paper or other physical media bearing information which is readable unaided by the typical human eye. An electronic document is any electronic media content (other than a computer program or a system file) that is intended to be used in either an electronic form or as printed output. Electronic documents may consist of a single data file, or an associated collection of data files which together are a unitary whole. Electronic documents will be referred to further herein as a document, unless the context requires some discussion of physical documents which will be referred to by that name specifically.

In printing, the MFP automatically produces a physical document from an electronic document. In copying, the MFP automatically produces a physical document from a physical document. In scanning, the MFP automatically produces an electronic document from a physical document. In faxing, the MFP automatically transmits via fax an electronic document from an input physical document which the MFP has also scanned or from an input electronic document which the MFP has converted to a fax format.

MFPs are often incorporated into corporate or other organization's networks which also include various other workstations, servers and peripherals. An MFP may also provide remote document processing services to external or network devices.

A document including a watermark indicates to a recipient of that document that it was created by that organization or user. Organizations may wish to keep individuals from applying watermarks to documents not associated with the organization. Previous methods of control of watermark access have been limited to general authorization via controlled access to a directory including the watermark or to group-based authorization.

### DESCRIPTION OF THE DRAWINGS

FIG. 1 is a diagram of an MFP system.

FIG. 2 is a block diagram of an MFP.

FIG. 3 is a block diagram of a computing device.

FIG. 4 is a block diagram of a software system for an MFP.

FIG. 5 is a block diagram of a system for secure watermarking of print jobs using a smartcard.

FIG. 6 is a flowchart of a process for secure watermarking of print jobs using a smartcard from the perspective of the client computer.

FIG. 7 is a flowchart of a process for secure watermarking of print jobs using a smartcard from the perspective of the multifunction peripheral.

Throughout this description, elements appearing in figures are assigned three-digit reference designators, where the most significant digit is the figure number and the two least significant digits are specific to the element.

### DETAILED DESCRIPTION

Description of Apparatus

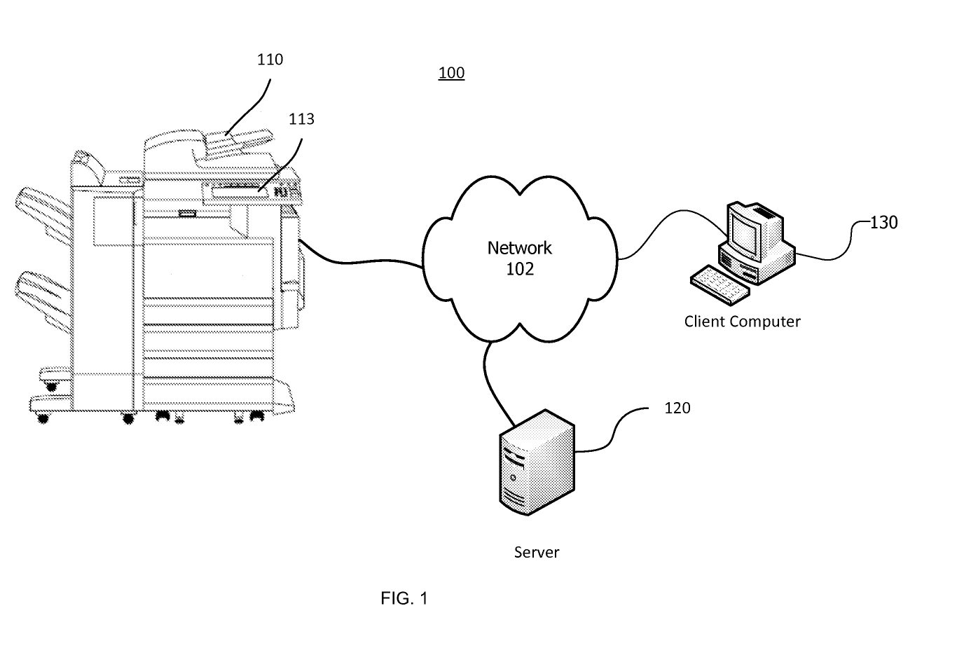

FIG. 1 shows a block diagram of a system 100. The system 100 includes an MFP 110, a server 120, and a client computer 130, all interconnected by a network 102. The system 100 may be, for example, implemented in a distributed computing environment and interconnected by the network 102.

The network 102 may be a local area network, a wide area network, a personal area network, the Internet, an intranet, or any combination of these. The network 102 may have physical layers and transport layers according to IEEE 802.11, Ethernet or other wireless or wire-based communication standards and protocols such as WIMAX®, BLUETOOTH®, the public switched telephone network, a proprietary communications network, infrared, and optical.

The MFP 110 may be equipped to receive portable storage media such as a USB drive. The MFP 110 may include a user interface subsystem 113 which communicates information to and receives selections from users. The user interface subsystem 113 may have a user output device for displaying graphical elements, text data or images to a user and a user input device for receiving user inputs. The user interface subsystem 113 may include a touchscreen, LCD display, touch-panel, alpha-numeric keypad and/or an associated thin client through which a user may interact directly with the MFP 110.

The server 120 may include software operating on a server computer connected to the network. The client computer 130 may be a PC, thin client or other device. The client computer 130 is representative of one or more end-user devices and may be considered separate from the system 100.

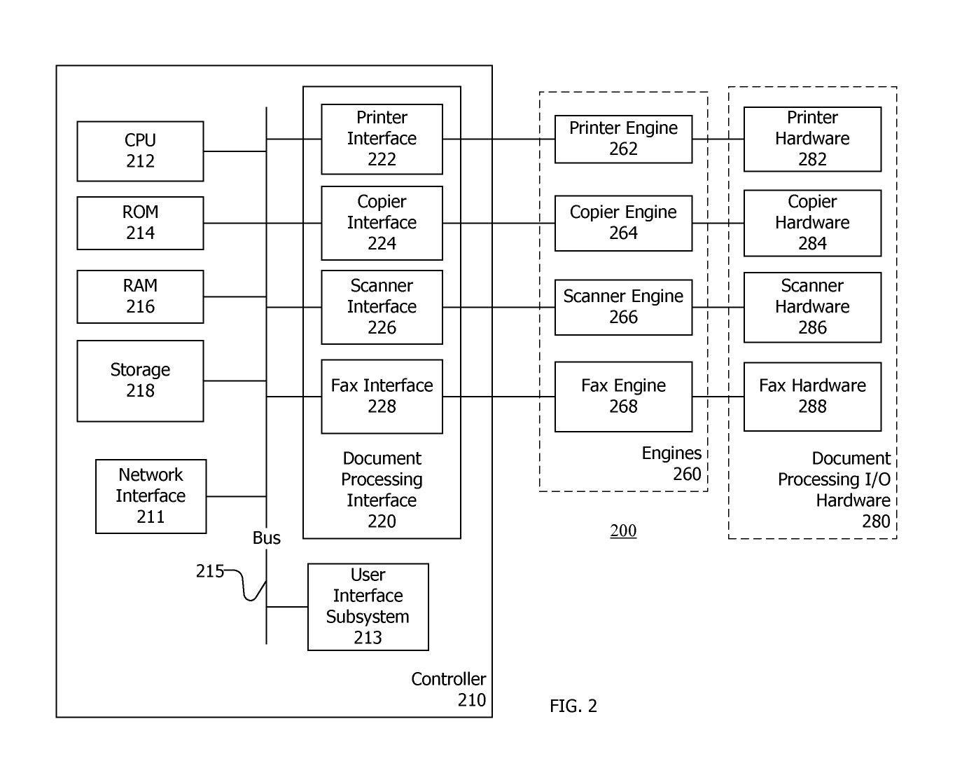

Turning now to FIG. 2, there is shown a block diagram of an MFP 200 which may be the MFP 110 (FIG. 1). The MFP 200 includes a controller 210, engines 260 and document processing I/O hardware 280. The controller 210 includes a CPU 212, a ROM 214, a RAM 216, a storage 218, a network interface 211, a bus 215, a user interface subsystem 213 and a document processing interface 220.

As shown in FIG. 2 there are corresponding components within the document processing interface 220, the engines 260 and the document processing I/O hardware 280, and the components are respectively communicative with one another. The document processing interface 220 has a printer interface 222, a copier interface 224, a scanner interface 226 and a fax interface 228. The engines 260 include a printer engine 262, a copier engine 264, a scanner engine 266 and a fax engine 268. The document processing I/O hardware 280 includes printer hardware 282, copier hardware 284, scanner hardware 286 and fax hardware 288.

The MFP 200 is configured for printing, copying, scanning and faxing. However, an MFP may be configured to provide other document processing functions, and, as per the definition, as few as two document processing functions.

The CPU 212 may be a central processor unit or multiple processors working in concert with one another. The CPU 212 carries out the operations necessary to implement the functions provided by the MFP 200. The processing of the CPU 212 may be performed by a remote processor or distributed processor or processors available to the MFP 200. For example, some or all of the functions provided by the MFP 200 may be performed by a server or thin client associated with the MFP 200, and these devices may utilize local resources (e.g., RAM), remote resources (e.g., bulk storage), and resources shared with the MFP 200.

The ROM 214 provides non-volatile storage and may be used for static or fixed data or instructions, such as BIOS functions, system functions, system configuration data, and other routines or data used for operation of the MFP 200.

The RAM 216 may be DRAM, SRAM or other addressable memory, and may be used as a storage area for data instructions associated with applications and data handling by the CPU 212.

The storage 218 provides volatile, bulk or long term storage of data associated with the MFP 200, and may be or include disk, optical, tape or solid state storage. The three storage components, ROM 214, RAM 216 and storage 218 may be combined or distributed in other ways, and may be implemented through SAN, NAS, cloud or other storage systems.

The network interface 211 interfaces the MFP 200 to a network, such as the network 102 (FIG. 1), allowing the MFP 200 to communicate with other devices.

The bus 215 enables data communication between devices and systems within the MFP 200. The bus 215 may conform to the PCI Express or other bus standard.

While in operation, the MFP 200 may operate substantially autonomously. However, the MFP 200 may be controlled from and provide output to the user interface subsystem 213, which may be the user interface subsystem 113 (FIG. 1).

The document processing interface 220 may be capable of handling multiple types of document processing operations and therefore may incorporate a plurality of interfaces 222, 224, 226 and 228. The printer interface 222, copier interface 224, scanner interface 226, and fax interface 228 are examples of document processing interfaces. The interfaces 222, 224, 226 and 228 may be software or firmware.

Each of the printer engine 262, copier engine 264, scanner engine 266 and fax engine 268 interact with associated printer hardware 282, copier hardware 284, scanner hardware 286 and facsimile hardware 288, respectively, in order to complete the respective document processing functions. These engines may be software, firmware or a combination of both that enables the document processing interface 220 to communicate with the document processing I/O hardware 280.

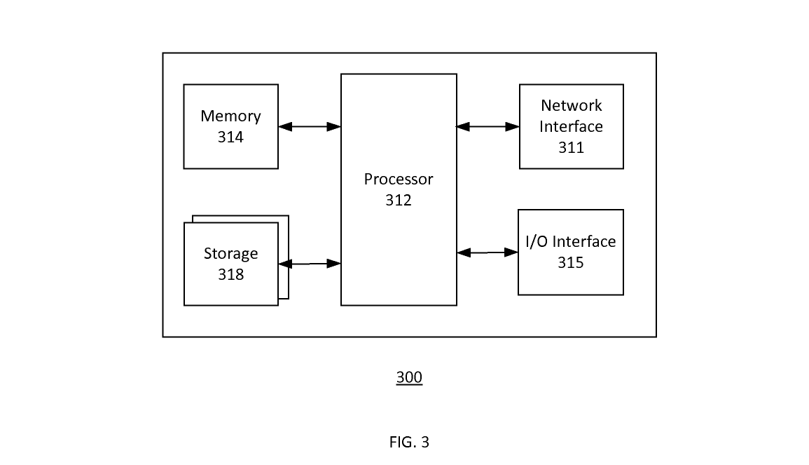

Turning now to FIG. 3 there is shown a computing device 300, which is representative of the server computers, client devices and other computing devices discussed herein. The controller 210 (FIG. 2) may also, in whole or in part, incorporate a general purpose computer like the computing device 300. The computing device 300 may include software and/or hardware for providing functionality and features described herein. The computing device 300 may therefore include one or more of: logic arrays, memories, analog circuits, digital circuits, software, firmware and processors. The hardware and firmware components of the computing device 300 may include various specialized units, circuits, software and interfaces for providing the functionality and features described herein.

The computing device 300 has a processor 312 coupled to a memory 314, storage 318, a network interface 311 and an I/O interface 315. The processor may be or include one or more microprocessors, field programmable gate arrays (FPGAs), application specific integrated circuits (ASICs), programmable logic devices (PLDs) and programmable logic arrays (PLAs).

The memory 314 may be or include RAM, ROM, DRAM, SRAM and MRAM, and may include firmware, such as static data or fixed instructions, BIOS, system functions, configuration data, and other routines used during the operation of the computing device 300 and processor 312. The memory 314 also provides a storage area for data and instructions associated with applications and data handled by the processor 312.

The storage 318 provides non-volatile, bulk or long term storage of data or instructions in the computing device 300. The storage 318 may take the form of a disk, tape, CD, DVD, or other reasonably high capacity addressable or serial storage medium. Multiple storage devices may be provided or available to the computing device 300. Some of these storage devices may be external to the computing device 300, such as network storage or cloud-based storage.

As used herein, the term storage medium corresponds to the storage 318 and does not include transitory media such as signals or waveforms.

The network interface 311 includes an interface to a network such as network 102 (FIG. 1).

The I/O interface 315 interfaces the processor 312 to peripherals (not shown) such as displays, keyboards and USB devices.

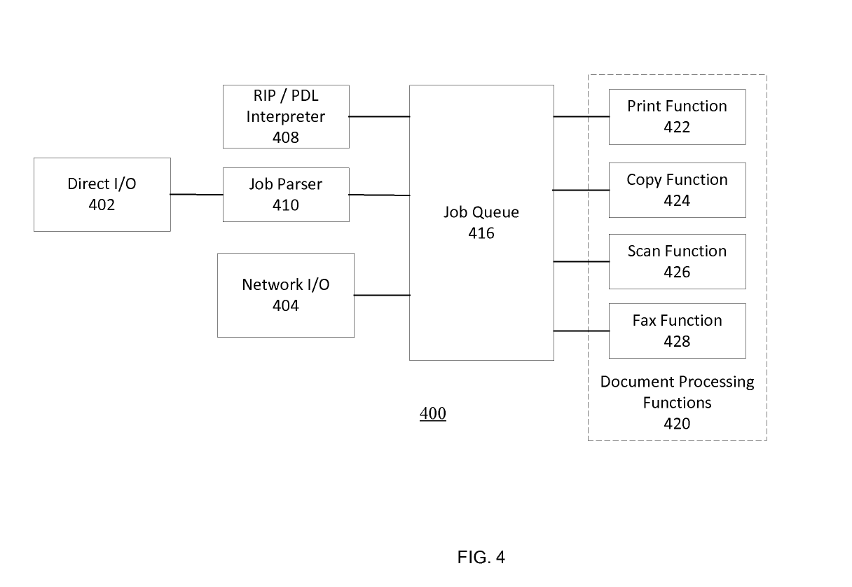

Turning now to FIG. 4 there is shown a block diagram of a software system 400 of an MFP which may operate on the controller 210 (FIG. 2). The system 400 includes direct I/O 402, network I/O 404, a RIP/PDL interpreter 408, a job parser 410, a job queue 416, a series of document processing functions 420 including a print function 422, a copy function 424, a scan function 426 and a fax function 428.

The direct I/O 402 and the network I/O 404 provide input and output to the MFP controller. The direct I/O 402 is for the user interface on the MFP (e.g., user interface subsystem 113), and the network I/O 404 is for user interfaces over the network. This input and output may include documents for printing or faxing or parameters for MFP functions. In addition, the input and output may include control of other operations of the MFP. The network-based access via the client network I/O 404 may be accomplished using HTTP, FTP, UDP, electronic mail, TELNET, or other network communication protocols.

The RIP/PDL interpreter 408 transforms PDL-encoded documents received by the MFP into raster images or other forms suitable for use in MFP functions and output by the MFP. The RIP/PDL interpreter 408 processes the document and adds the resulting output to the job queue 416 to be output by the MFP.

The job parser 410 interprets a received document and relays it to the job queue 416 for handling by the MFP. The job parser 410 may perform functions of interpreting data received so as to distinguish requests for operations from documents and operational parameters or other elements of a document processing request.

The job queue 416 stores a series of jobs for completion using the document processing functions 420. Various image forms, such as bitmap, page description language or vector format may be relayed to the job queue 416 from the scan function 426 for handling. The job queue 416 is a temporary repository for all document processing operations requested by a user, whether those operations are received via the job parser 410, the client direct I/O 402 or the network I/O 404. The job queue 416 and associated software is responsible for determining the order in which print, copy, scan and facsimile functions are carried out. These may be executed in the order in which they are received, or may be influenced by the user, instructions received along with the various jobs or in other ways so as to be executed in different orders or in sequential or simultaneous steps. Information such as job control, status data, or electronic document data may be exchanged between the job queue 416 and users or external reporting systems.

The job queue 416 may also communicate with the job parser 410 in order to receive PDL files from the direct I/O 402. The direct I/O 402 may include printing, fax transmission or other input of a document for handling by the system 400.

The print function 420 enables the MFP to print documents and implements each of the various functions related to that process. These include stapling, collating, hole punching, and similar functions. The copy function 422 enables the MFP to perform copy operations and all related functions such as multiple copies, collating, 2 to 1 page copying or 1 to 2 page copying and similar functions. Similarly, the scan function 426 enables the MFP to scan and to perform all related functions such as shrinking scanned documents, storing the documents on a network or emailing those documents to an email address. The fax function 426 enables the MFP to perform facsimile operations and all related functions such as multiple number fax or auto-redial or network-enabled facsimile.

Some or all of the document processing functions 420 may be implemented on a client computer, such as a personal computer or thin client. The user interface for some or all document processing functions may be provided locally by the MFP's user interface subsystem though the document processing function is executed by a computing device separate from but associated with the MFP.

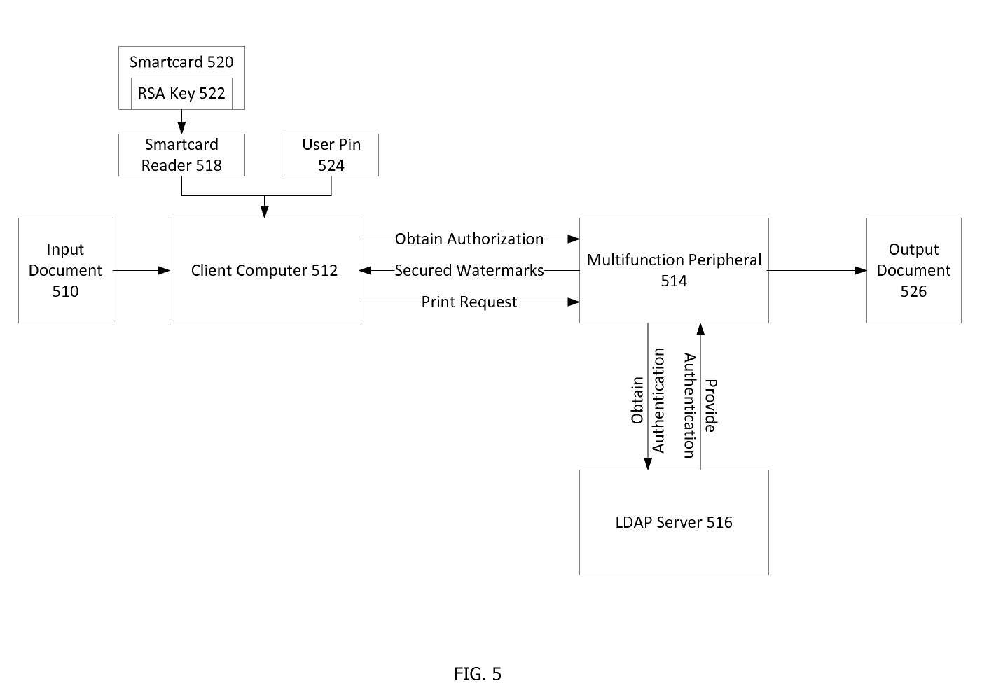

Turning now to FIG. 5, a block diagram of a system for secure watermarking of print jobs using a smartcard showing component interactions is shown. An input document 510 is provided to the system which includes a client computer 512, a multifunction peripheral 514, and an LDAP server 516. The client computer 512 interfaces with a smartcard reader 518 that is capable of accepting a smart card 520 including an RSA key 522. The client computer 512 can also accept the input of a user pin 524.

The client computer 512 may be used to access an input document 510 for printing. This document may be printed directly from a word processor operating on the client computer 512, may be accessed from a directory of the hard disk drive of the client computer 512, may be obtained from a remote directory or server accessible to the client computer 512. The user of the client computer 512 desires to print the input document 510 including a secured watermark. The user utilizes the client computer 512 to generate the print request including a secured watermark instruction requesting the multifunction printer to include a secured watermark in the resulting printed document.

The client computer 512 also includes or has access to a smartcard reader 518. The smartcard reader 518 may be used to accept a smartcard 520 including an RSA key 522. The smartcard 520 may include an X.509 certificate as the user's RSA public key. The RSA key 522 is the user's RSA private key that may be used to digitally sign the input document 510 before it is sent to the multifunction peripheral 514 for output. The X.509 certificate as the user's RSA public key may be stored on the smartcard 520 or may be available in a database available to the multifunction peripheral device. Access to the RSA key 522 on the smartcard 520 is only granted to a user of the client computer 512 upon the input of a user pin 524 matching the smartcard 520.

Upon receipt of a print request including a secured watermark instruction, the client computer 512 may request access to the secured watermarks accessible to the multifunction peripheral 514. This request may be digitally signed using the user's input RSA key 522 and user pin 524 in order to securely identify the user. Authorization by the multifunction peripheral 514 is required because the use of a secured watermark is secured by the multifunction peripheral 514. Further, the multifunction peripheral 514 stores the secured watermarks in storage (such as storage 218, see FIG. 2) internal or otherwise accessible to the multifunction peripheral 514.

The multifunction peripheral 514 is capable of decrypting a user authorization request received from the client computer 512 in order to obtain the identity information provided by the user of the client computer 512. This decryption uses the user's public RSA key in order to determine that the request is authentic. Once the user's identity is determined, the multifunction peripheral may communicate that identity to the associated LDAP server 516 to ensure that the user is authorized to use secured watermarks. A user may be authorized to use some, but not all, of the secured watermarks on the multifunction peripheral.

Once the multifunction peripheral 514 receives the authorization data from the LDAP server 516 that indicates that the user is authorized to view secured watermarks, it can provide a listing of available secured watermarks to the client computer 512. This listing may be limited based upon the set of secured watermarks, of the available total set of secured watermarks, that the user identified by the identity information is authorized to access or apply to documents. Once received at the client computer 512, the user may select one of the available listing of secured watermarks for inclusion in the user's print request.

The client computer 512 sends its print request to the multifunction peripheral 514. The print request is encrypted and digitally signed using the RSA key 522 obtained from the smartcard 520 via the smartcard reader 518. The user's identity is confirmed using the user pin 524. The print request includes a secured watermark instruction, not a secured watermark. In order to maintain the security of the secured watermark, a secured watermark instruction, identifying the requested watermark, is sent in lieu of the actual secured watermark. This instruction identifies the location, layout, position, size and other parameters related to the secured watermark to be applied to the document that is the subject of the print request.

The signed print request is sent to the multifunction peripheral. Once the signed print request is received, the digital signature is decrypted using the requesting user's public RSA key. This process may take place automatically by drawing the user's public RSA key from a shared directory of public RSA keys or may require the user to reauthenticate at the multifunction peripheral using the smartcard 520 and the user pin 524. In either embodiment, the encrypted signed print request may be decrypted and the identity of the individual providing the digital signature is determined.

The identity of the user associated with the print request may be checked using the LDAP server 516 to determine that the user, now authenticated, is authorized to utilize the secured watermark identified by the secured watermark instruction in the print request. Once the multifunction peripheral 514 receives confirmation of the user's identity and that user's authority to utilize the secured watermark identified by the secured watermark instruction, the multifunction peripheral can apply the secured watermark as described in the print request to the document and output that document as output document 526.

Description of Processes

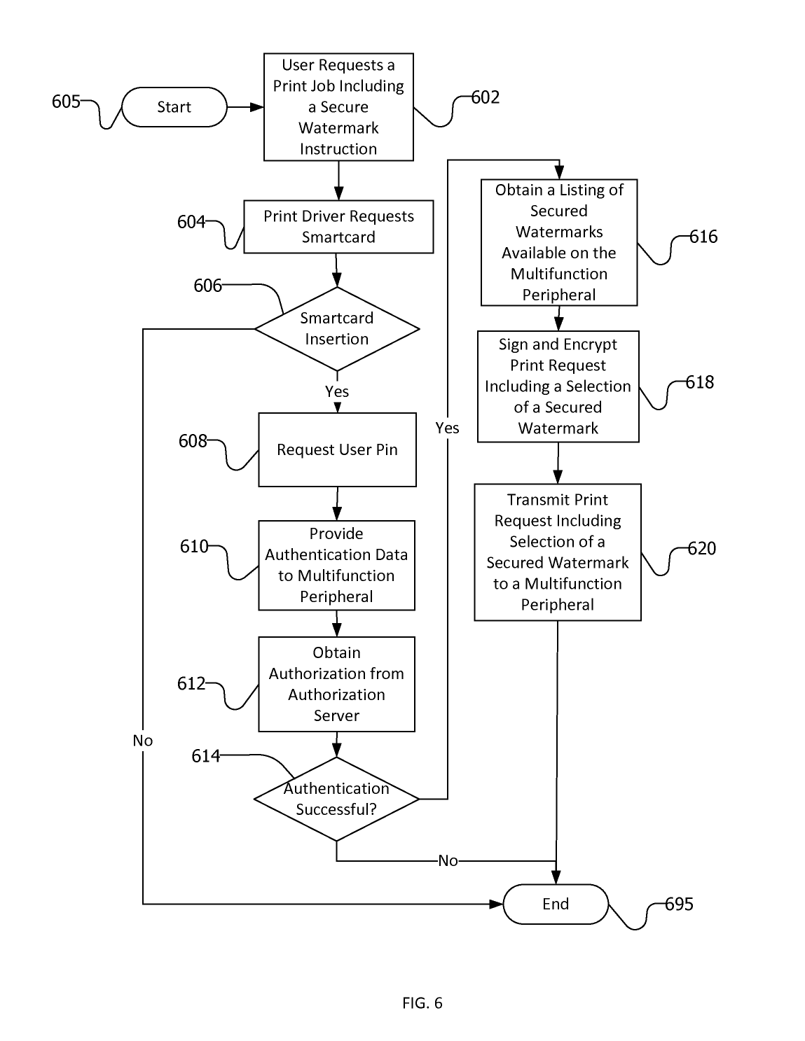

Turning now to FIG. 6, a flowchart of a process for secure watermarking of print jobs using a smartcard from the perspective of the client computer is shown. First, a user requests a print job including a secure watermark instruction at 602. The user identifies a document or documents for printing and requests that a secured watermark be included in the document. The request for the secured watermark may be made by the print driver and, therefore, is inserted as one of the finishing operations of the document.

The print driver, as a part of this process requests a smartcard at 604 associated with the user. This request may take the form of a popup window or may be a built-in aspect of the user interface such that the option to insert a secured watermark may be unavailable until the user has inserted a smartcard. At 606, the presence of the smartcard 606 is confirmed. If no smartcard is inserted at 606, then the process ends 695 and the user's request to insert a secured watermark is denied. The user may carry on with the printing process, but a secured watermark will not be included.

If a smartcard is inserted at 606, then the print driver may request a user pin at 608. This request may be via a part of the prior popup or may appear after the smartcard is inserted as a separate popup or may appear, as described above, as a part of the print driver's default interface of finishing operations.

Once the smartcard and pin have been accepted, the authentication data is provided to the multifunction peripheral at 610. This authentication data includes the user's smartcard, which may include a username or may utilize a private RSA key along with the user pin to encrypt and digitally sign a request for access to a listing of secured watermarks available on the selected multifunction peripheral device.

Once received at the multifunction peripheral, the authentication data may be decrypted using the user's public RSA key to ensure the identity of the user making the request. The decrypted authentication data may then be used by the multifunction peripheral to obtain authorization from a server at 612. This server may be, for example, an LDAP server (lightweight directory access server) which maintains a database of secured watermarks that the user associated with the authentication data is authorized to use. The server then returns authorization data to the multifunction peripheral.

If the authentication is not successful at 614, then the application of a secured watermark will be denied and the process will end at 695. The print job may continue, but it will not include a secured watermark. If the authentication is successful at 614, then the client computer that made the print request will obtain a listing of the secured watermarks available on the multifunction peripheral at 616. This listing may be a listing of all secured watermarks or may be a subset of a complete set of secured watermarks depending on the set of secured watermarks that the user is authorized to apply to print requests.

Next, the user's private RSA key and pin are used to digitally sign and encrypt a print request including a secured watermark instruction. The secured watermark instruction includes selection of a secured watermark from the listing of available secured watermarks at 618. This secured watermark instruction does not include the image or other file making up the secured watermark, only an instruction as to which secured watermark to use and where and how to place it on the resulting printed document.

In the signing process, the private RSA key and pin are used to create a print request digest. The print request digest is encrypted with the private RSA key and this encrypted print request digest is attached to the print request including the secured watermark instruction. This signature may be used once the print request is received to ensure the identity of the user transmitting the print request.

Finally, the signed print request including a selection of a secured watermark is transmitted to a multifunction peripheral for printing 620. The signed print request, including the encrypted print request digest and the print request is transmitted.

The flow chart of FIG. 6 has both a start 605 and an end 695, but the process is cyclical in nature and may include one or more simultaneous instances taking place in parallel or in serial.

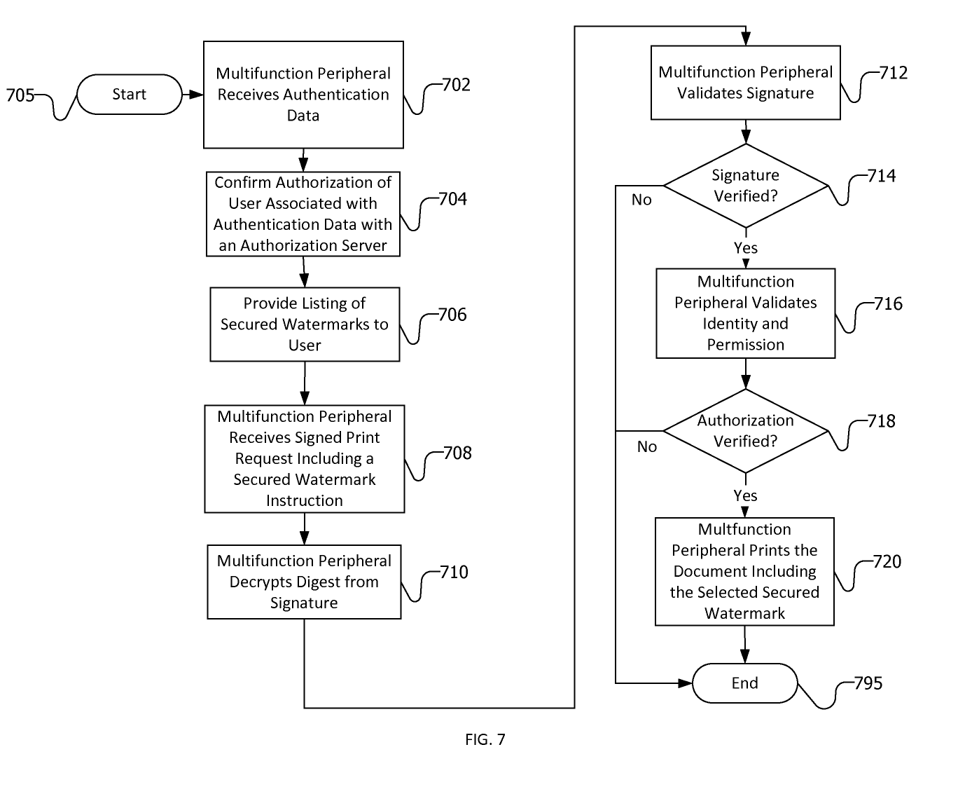

FIG. 7 shows a flowchart of a process for secure watermarking of print jobs using a smartcard from the perspective of the multifunction peripheral. First, the multifunction peripheral receives authentication data 702. This may be the authentication data sent at 610 in FIG. 6. The multifunction peripheral passes the authorization data to an authorization server in order to confirm authorization of the associated user to access one or more secured watermarks at 704. The secured watermarks are stored on the multifunction peripheral.

Once authorization is confirmed, the multifunction peripheral provides a listing of secured watermarks to the user at 706. This listing may be a listing of all secured watermarks available on the multifunction peripheral or in associated secure storage. Alternatively, the listing may be a subset of all that the user is authorized to access for printing. The listing is provided at 706, and used at 618 (FIG. 6) to select a secured watermark.

Once the client has utilized the listing of secured watermarks to select one and to generate a print request as described with reference to FIG. 6 above, the multifunction peripheral receives a signed print request including a secured watermark instruction at 708. This may be the signed request sent at 620 (FIG. 6) above. Upon receipt of the signed print request, the multifunction peripheral decrypts the print request digest from the signature using the associated user's public RSA key at 710. This public RSA key may be stored on the multifunction peripheral, on a storage device available to the multifunction peripheral or may be stored alongside the user's private RSA key on a smartcard.

Next, the multifunction peripheral validates the signature at 712. In so doing, the decrypted digest is compared with a digest generated on the multifunction peripheral by applying a digest function to the print request sent along with the encrypted signature.

At 714, the signature is verified. In order to do this, the decrypted digest is compared to the multifunction peripheral generated digest. If the comparison between the two yields identical digests based upon the user's public RSA key, then the signature is valid for that user.

A multifunction peripheral may also require that the user associated with the print request login at the multifunction peripheral in order to begin the validation process. The user may utilize a login and password or the smartcard and pin combination used to create the print request in order to do so. This may provide yet another level of protection against the unauthorized use of secured watermarks.

If the signature is not verified at 714, then the multifunction peripheral will cancel the print job utilizing the secured watermarks. If the signature is verified at 714, then, the multifunction peripheral confirms the identity of the signer and that signer's permission to use the secured watermark identified by the secured watermark instruction at 716.

The validation process uses the secure signature provided using the RSA keys to obtain the identity of the individual sending the print request. In this way, the authentication of that user may be confirmed. Once authenticated, authorization may be verified at 718. Here, the multifunction peripheral again confirms that the user is authorized to utilize the selected secured watermark. This may take place using an LDAP server in order to confirm the secured watermarks that the user identified by the signature is authorized to access.

If permission for the secured watermark identified by the secured watermark instruction is not verified at 718, then the multifunction peripheral will terminate the print job including the secured watermark instruction. If permission is verified at 718, then the multifunction peripheral will print the document including the selected secured watermark identified by the secured watermark instruction at 720.

The flow chart of FIG. 7 has both a start 705 and an end 795, but the process is cyclical in nature and may include one or more simultaneous instances taking place in parallel or in serial.

Although the system and process are described with respect to a secure print job, similar systems and methods may be employed for other forms of document processing operations. For example, a user-requested facsimile or email transmission may utilize identical systems and processes until the final steps in which the document is sent via facsimile or via email rather than being output as a physical document.

Closing Comments

Throughout this description the embodiments and examples shown should be considered as exemplars, rather than limitations on the apparatus and procedures disclosed or claimed. Although many of the examples presented herein involve specific combinations of method acts or system elements, it should be understood that those acts and those elements may be combined in other ways to accomplish the same objectives. With regard to flowcharts, additional and fewer steps may be taken, and the steps as shown may be combined or further refined to achieve the methods described herein. Acts, elements and features discussed only in connection with one embodiment are not intended to be excluded from a similar role in other embodiments.

As used herein, “plurality” means two or more. As used herein, a “set” of items may include one or more of such items. As used herein, whether in the written description or the claims, the terms “comprising”, “including”, “carrying”, “having”, “containing”, “involving”, and the like are to be understood to be open-ended, i.e., to mean including but not limited to. Only the transitional phrases “consisting of” and “consisting essentially of”, respectively, are closed or semi-closed transitional phrases with respect to claims. Use of ordinal terms such as “first”, “second”, “third”, etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements. As used herein, “and/or” means that the listed items are alternatives, but the alternatives also include any combination of the listed items.

It is claimed:

1. A method for secure watermarking of print jobs using a smartcard:
receiving, from a user, a request to print a document with a secured watermark;
obtaining authorization data from a smartcard provided by the user;
receiving, from the user, pin associated with the smartcard;
obtaining authorization to print with a secured watermark from an authorization server based on the authorization data and the user pin;
obtaining a listing of secured watermarks available on a multifunction peripheral;
receiving, from the user, a selection of a selected secured watermark from the listing of secured watermarks; and
transmitting a print request to the multifunction peripheral, the print request including a secured watermark instruction and authorization to use the selected secured watermark.

2. The method of claim 1 wherein the smartcard includes an RSA private key.

3. The method of claim 2 wherein the authorization server is an LDAP server.

4. The method of claim 3 wherein the authorization is obtained by transmitting a digitally signed secured watermark listing request, created using the RSA private key and the user pin, to the multifunction peripheral to confirm authorization to access the listing of secure watermarks using the LDAP server.

5. The method of claim 2 wherein the print request is encrypted and digitally signed using the RSA private key and the user pin before it is transmitted to the multifunction peripheral device.

6. The method of claim 5 further comprising:
receiving the print request at the multifunction peripheral device;
accepting input of a decryption key in order to decrypt the print request;
confirming that the user identified by the print request is authorized to utilize the selected secured watermark;
applying the selected secured watermark stored in the multifunction peripheral as directed by the print request; and
outputting a physical document as directed by the print request, the physical document incorporating the selected secured watermark.

7. A system comprising a client computer, the client computer including:
a network interface for receiving, from a user, a request to print a document with a secured watermark instruction;
an input/output interface for accepting input of a smartcard in order to obtain authorization data from a smartcard provided by the user;
a user interface for requesting user input of a user pin associated with the smartcard;
the network interface further for obtaining authorization from an authorization server using the authorization data and the user pin and for obtaining a listing of secured watermarks available on a multifunction peripheral;
the user interface further for receiving, from the user, a selection of a selected secured watermark from the listing of secured watermarks; and
the network interface for transmitting a print request to the multifunction peripheral, the print request including a secured watermark instruction and authorization to use the selected secured watermark.

8. The system of claim 7 wherein the smartcard includes an RSA private key.

9. The system of claim 8 wherein the authorization server is an LDAP server.

10. The system of claim 9 wherein the authorization is obtained by transmitting a digitally signed secured watermark listing request, created using the RSA private key and the user pin, to the multifunction peripheral to confirm authorization to access the listing of secure watermarks using the LDAP server.

11. The system of claim 8 wherein the print request is encrypted and digitally signed using the RSA private key and the user pin before it is transmitted to the multifunction peripheral device.

12. The system of claim 11 further comprising the multifunction peripheral, the multifunction peripheral further comprising:
a network interface for receiving the print request at the multifunction peripheral device and for accepting input of a decryption key in order to decrypt the print request and for confirming that the user identified print request is authorized to utilize the selected secured watermark;
a controller for applying the selected secured watermark stored in the multifunction peripheral as directed by the print request; and
a printer engine for outputting a physical document as directed by the print request, the physical document incorporating the selected secured watermark.

13. Apparatus comprising a storage medium storing a program having instructions which, when executed by a processor, causes the processor to:
receive a print request for a document, the print request including a secured watermark instruction;
request user input of a smartcard for user authorization to include the secured watermark instruction in the print request;
accept input of a smartcard;
obtain authorization data from the smartcard;
receive a user pin associated with the smartcard;
obtain authorization from an authorization server;
obtain a listing of secured watermarks available on a multifunction peripheral available to complete the print request;
receive a user selection of a selected secured watermark from the listing of secured watermarks; and
transmit the print request to the multifunction peripheral, the print request including authorization to use the selected secured watermark via the smartcard and pin.

14. The storage medium of claim 13 wherein the smartcard includes an RSA private key.

15. The storage medium of claim 14 wherein the authorization server is an LDAP server.

16. The storage medium of claim 15 wherein the authorization is obtained by transmitting a digitally signed secured watermark listing request, created using the RSA private key and the user pin, to the multifunction peripheral to confirm authorization to access the listing of secure watermarks using the LDAP server.

17. The storage medium of claim 14 wherein the print request is encrypted and digitally signed using the RSA private key and the user pin before it is transmitted to the multifunction peripheral device.

18. Apparatus comprising a storage medium storing a program having instructions which, when executed by a processor, causes the processor to:
receive the print request at the multifunction peripheral device;
accept input of a decryption key in order to decrypt the print request;
confirm that the user identified by the print request is authorized to utilize the selected secured watermark;
apply the selected secured watermark stored in the multifunction peripheral as directed by the print request; and
output a physical document as directed by the print request, the physical document incorporating the selected secured watermark.
